(19) United States
(12) Patent Application Publication
(10) Pub. No.: US 2014/0157246 A1
(43) Pub. Date: Jun. 5, 2014

(54) BUILDING CROSS-PLATFORM ASYNCHRONOUS GAMES

(71) Applicant: ZYNGA INC., San Francisco, CA (US)

(72) Inventor: Jason Tomlinson, Fairview, TX (US)

(73) Assignee: ZYNGA INC., San Francisco, CA (US)

(21) Appl. No.: 14/096,817

(22) Filed: Dec. 4, 2013

Related U.S. Application Data
(60) Provisional application No. 61/733,236, filed on Dec. 4, 2012.

(51) Int. Cl. G06F 9/45

(52) U.S. Cl. CPC G06F 8/41
USPC 717/140

(57) ABSTRACT

A system, computer-readable storage medium storing at least one program, and a computer-implemented method are discussed herein. For example, an embodiment may access a game engine that defines game play logic specifying an execution of a turn in an asynchronous game. The game play logic may be independent of a client device platform. The embodiment may then select a native platform library that includes functions to coordinate game activities within the asynchronous game. The functions may be dependent on the client device platform. The embodiment may then generate an executable game based on compiling the selected native platform library with the game engine.

### CROSS REFERENCE TO RELATED APPLICATIONS

This application claims priority from U.S. Provisional Application No. 61/733,236, entitled “Building Cross Platform Synchronous Games” and filed Dec. 4, 2012, all of which is incorporated herein by reference in its entirety for all purposes.

### TECHNICAL FIELD

The subject matter disclosed herein generally relates to the processing of data. Specifically, the present disclosure relates to systems and methods for building and executing cross-platform games.

### BACKGROUND

Typically, online games are built (e.g., compiled into executable form, such as binary files) using separate development code bases that are each specific to a target platform (e.g., operating system) running on a client device. For example, an online game being released on both the Android® platform and the iOS® platform may be built from distinct code bases, one for each the Android® platform and one for the iOS® platform. Consequently, when functionality changes in a game, the developer typically updates the development branches associated with each separate platform to incorporate those changes. That is, a developer using traditional development systems and traditional game architectures may have to propagate changes to a development branch for the iOS® platform and also to the Android® platform, and any other platforms the game is being released on.

### BRIEF DESCRIPTION OF THE DRAWINGS

Some embodiments are illustrated by way of example and not limitation in the figures of the accompanying drawings.

FIG. 1 is a system diagram illustrating an example of a gaming environment for implementing various example embodiments.

FIG. 2 is a diagram showing an example of a social network within a social graph, according to some example embodiments.

FIG. 3 is a block diagram depicting various modules, in accordance with an example embodiment, that may be included in the build platform of FIG. 1.

FIG. 4 is a diagram illustrating a native game, as may be executed on the client device of FIG. 1, sending asynchronous game messages to the gaming platform, according to an example embodiment.

FIG. 5 is a diagram illustrating an example data model utilized by a native platform library, according to an example embodiment.

FIG. 6 is a flowchart diagram illustrating a method for generating asynchronous games across different client device platforms, according to an example embodiment.

FIGS. 7-9 are sequence diagrams illustrating example use cases, according to example embodiments.

FIG. 10 illustrates an example data flow between example components of an example system, according to an example embodiment.

FIG. 11 illustrates an example network environment, in which various example embodiments may operate.

FIG. 12 illustrates an example computing system architecture, which may be used to implement a server or a client system, according to some example embodiments.

### DETAILED DESCRIPTION

Example methods and systems may be directed to a platform operable to build, deploy, and execute asynchronous games. Unless explicitly stated otherwise, components and functions are optional and may be combined or subdivided, and operations may vary in sequence or be combined or subdivided. Although example embodiments have been described with reference to specific examples, it is to be appreciated that various modifications and changes may be made to these embodiments without departing from the broader spirit and scope of the invention.

The term “asynchronous game,” as used herein, may refer to a form of online game where multiple players of an instance of the game (also referred to herein as a “match”) play each other by taking successive turns in interacting with a game board. For example, the WordsWithFriends® game, as provided by Zynga®, allows two players to play a word forming game against each other in a turn-based manner. In such a turn-based game, a first player may perform one or more game actions on a game board, such as placing letter tiles at user-selected game locations, until their turn ends. A turn may end after a determinable time period or responsive to the first player submitting their turn to a gaming system. After the first player's turn ends, the gaming system may then allow the second player to play their turn. During the second player's turn, the second player will see the game board updated to reflect the game actions performed by the first player during the first player's turn. Further, the second player may also perform one or more game actions until their turn ends, as may occur after a determinable amount of time or upon initiation by the second player (e.g., the second player submits their turn). Thus, a match may involve a repeated sequence of the a first player performing their turn, the game system updating the game board to reflect the executed turn of the first player, allowing a second player to play their turn, and then the game system updating the game board to reflect the executed turn by the second player.

The above description illustrates properties common to many asynchronous games. To begin, many asynchronous games impose a sequence constraint on game play. For example, the sequence constraint may specify that a first player is to play a first turn, the second player is to play a second turn, the first player is to play a third turn, the second player is to play a fourth turn, and so forth. Between each successive turn, a game system may update the game state by applying updates caused by a game action performed during that turn.

Many asynchronous games impose weak timing constraints on game play. For example, the first and second players do not have to be simultaneously logged into the game in order for the game to operate. Instead, a first player may perform a first turn at a first point in time and then at some later point in time, the second player may access the game to perform a second turn.

It is to be appreciated that asynchronous games are distinct from synchronous games. For example, a synchronous game, such as World of Warcraft®, may allow multiple or even many players to play a game simultaneously. Accordingly, a game system supporting a synchronous game typically operates with strict time or sequencing constraints because those games typically operate by allowing nearly real-time interactions in free form.

In an example embodiment, a method or system may build an asynchronous game. For example, the example embodiment may access a game engine that defines functionality to perform, when executed by a game client, a turn in an asynchronous game. The example embodiment may then select a native platform library that includes functions that are executable by a client device platform. The functions may relate to operations performed by an asynchronous game framework, such as submitting a move or initiating a chat. The example embodiment may then generate an executable game based on compiling the selected native platform library with the game engine.

In some embodiments, an example embodiment may build another asynchronous game. For example, the example embodiment may then select a different native platform library that includes the same functions as the prior native platform library but are instead executable by a different client device platform. The example embodiment may then generate another executable game based on compiling the selected different native platform library with the game engine.

Thus, some example embodiments may provide across-platform build system for asynchronous games. Such a cross-platform build system may be used to improve development time for creating and releasing online games, for example. Such is the case because a native platform library may be used to provide game functionality common to asynchronous games. As the native platform library may be used to build multiple games, each game can leverage on the functionality provided by the native platform library. Further, as a game engine may access the functionality provided by the native platform library through a programming interface (e.g., C++ API), the game engine can be reused across multiple client device platforms. That is, the game engine may operate “on-top” of the native game experience in a way that abstracts the specifics of a particular platform (e.g., iOS®, Android®, Windows®, and the like).

### EXAMPLE SYSTEM

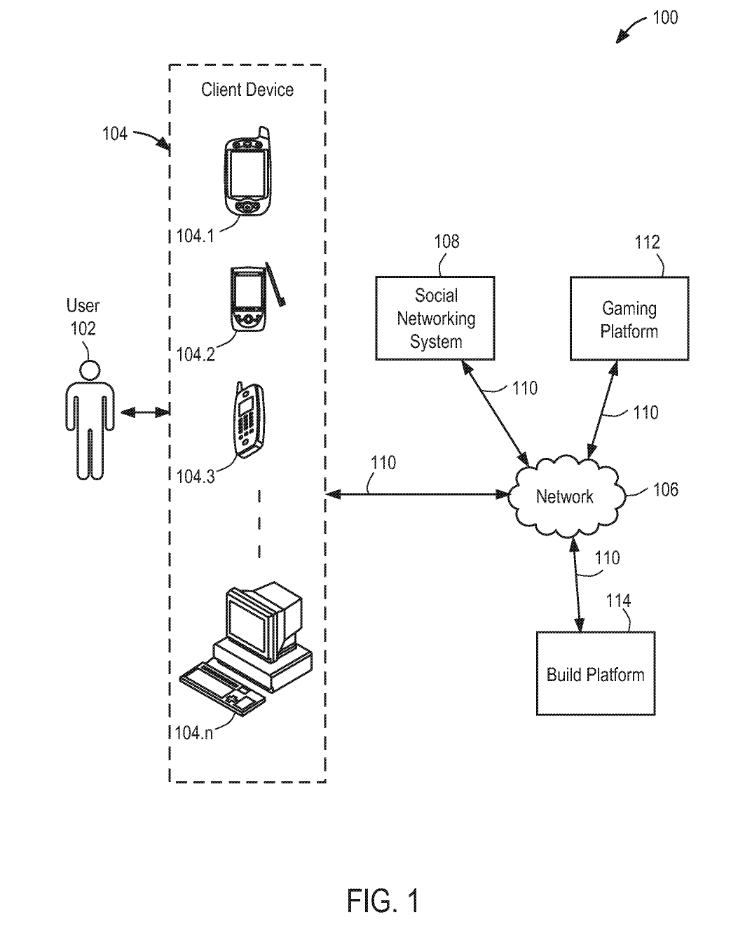

FIG. 1 is a system diagram illustrating an example of a gaming environment 100 for implementing various example embodiments. In some embodiments, the gaming environment 100 comprises a user 102, a client device 104, a network 106, a social networking system 108, and a gaining platform 112. The components of the gaming environment 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (AVIAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

Although FIG. 1 illustrates a particular example of the arrangement of the user 102, the client device 104, the social networking system 108, the gaming platform 112, and the network 106, any suitable arrangement or configuration of the user 102, the client device 104, the social networking system 108, the gaming platform 112, and the network 106 may be contemplated.

The client device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The client device 104 may access the social networking system 108 or the gaming platform 112 directly, via the network 106, or via a third-party system. For example, the client device 104 may access the gaming platform 112 via the social networking system 108.

In some embodiments, the client device 104 may be communicatively coupled to or include an input device, such as a keyboard, a pointing device, and a display device (not shown). Such input devices may allow a user to interact with a game provided by the gaming platform 112. For example, with the input devices, the client device 104 may allow a user to select (e.g., through a mouse click or a finger tap on a touch screen) a game object.

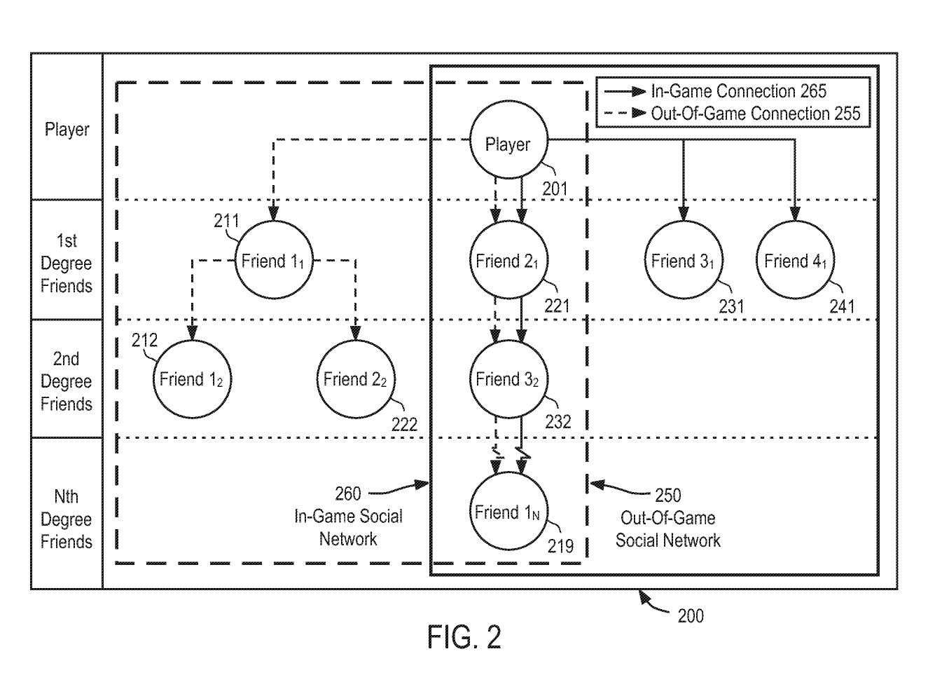

The social networking system 108 may include a network-addressable computing system that can host one or more social graphs (see for example FIG. 2), and may be accessed by the other components of system 100 either directly or via the network 106. The social networking system 108 may generate, store, receive, and transmit social networking data.

FIG. 2 is a diagram showing an example of a social network within a social graph 200. The social graph 200 is shown by way of example to include an out-of-game social network 250 and an in-game social network 260. Moreover, the in-game social network 260 may include one or more users that are friends with Player 201 (e.g., Friend 31 231), and may include one or more other users that are not friends with Player 201. The social graph 200 may correspond to the various users associated with the virtual game. In an example embodiment, player may send game requests to each other. For example, Player 201 may send communication (e.g., a breeding requests) to Friend 31 231. FIG. 2 and the social graph 200 are described in greater detail below.

With reference back to FIG. 1, the gaming platform 112 may include a network-addressable computing system (or systems) that can host one or more online games. The gaming platform 112 may generate, store, receive, and transmit game-related data, such as, for example, game account data, game input, game state data, and game displays. The gaming platform 112 may be accessed by the other components of the gaming environment 100 either directly or via the network 106. The user 102 may use the client device 104 to access, send data to, and receive data from the social networking system 108 and/or the gaining platform 112.

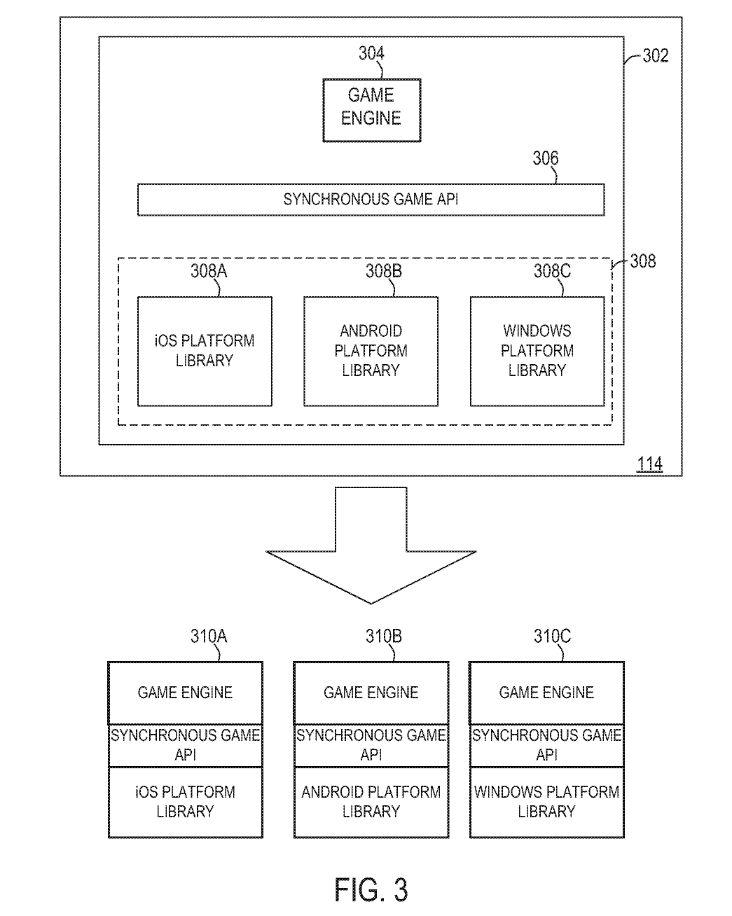

The build platform 114 may include a network-addressable computing system (or systems) that can build one or more asynchronous games. As described in greater detail below with reference to FIG. 3, the build platform 114, in some embodiments, may be configured to build an executable asynchronous game based on a game engine, a cross-platform asynchronous game application programming interface (API), and a selected native platform library.

The build platform 114 is now described in greater detail. FIG. 3 is a block diagram depicting various modules, in accordance with an example embodiment, that may be included in the build platform 114 of FIG. 1. Referring to FIG. 3, in various embodiments, the modules of the build platform shown in FIG. 3 may be used to execute computer programs, logic, applications, methods, processes, or software to build an asynchronous game, as described in more detail below.

As shown in FIG. 3, the build platform 113 may include a compilation module 302 configured to generate asynchronous games executable for particular client device platforms. For example, the compilation module 302 may compile a game engine 304, an asynchronous game API 306, and a native platform library (e.g., one of the platform specific native platform libraries 308A-C) from the framework library 308 to generate a platform specific asynchronous game (e.g., the platform specific games 310A-B).

The game engine 304 may be data and logic (e.g., software) developed by a game developer. The game engine 304 may specify game logic related to a turn of a game. For example, the game engine 304 may specify the data structure of a game board and how players may interact with the game board. By way of example and not limitation, the game engine 304 may specify that the game board is a grid and players may initiate game actions that place tiles representing letters onto the spaces created by the grid to form a word. The game engine 304 may be developed using Unity®, LUA®, Cocos2d-x®, JavaScript®, or any suitable game development language. In some embodiments, the game engine 304 may have the ability to communicate with the C++ programming language.

The asynchronous game API 306 may be a cross-platform interface that defines or otherwise declares method signatures supported by each of the platform specific native platform libraries 308A-C from the framework library 308. In an example embodiment, the method signatures declared by the asynchronous game API 306 may be used to invoke operations used to manage the execution of an asynchronous game. Such operations may include operations to: get a user identifier (“ID”), get a game ID, get move count, send a move, send a game aver move, get a game data object, and get a turn game count.

The framework library 308 may include the native platform libraries 308A-C. Each of native platform libraries 308A-C may include native code that executes on a particular client platform. For example, native platform library 308A may be configured to execute on the iOS® platform, the native platform library 308B may be configured to execute on the Android® platform, and the native platform library 308C may be configured to execute on the Windows® platform, The native platform libraries 308A-C provide code that support an asynchronous game in a number of ways. For example, the native platform libraries 308A-C may include code that implements the operations declared by the asynchronous game API 306. Thus, the game engine 304 may make calls through the asynchronous game API 306 to have a particular method or operation performed.

Further, each of the native platform libraries 308A-C may include native code that defines common user experiences in an asynchronous game. Such common user experiences may include mechanisms to login a user, display a list of ongoing games or matches, creating a game, storing data, facilitating chats, adjusting account settings, and the like. Further, each of the native platform libraries 308A-C may include native code for executing internal functions, such as communicating with a network, communicating with a social network (e.g., FACEBOOK®, LINKEDIN®, TWITTER®, etc), upgrading a software package, pushing advertisements, and the like.

Still further, the native (platform libraries 308A-C may provide a communication layer between a client side game and the gaming platform 112. Such a communication layer may exchange (e.g., push or pull) game state changes with the gaming platform 112.

The native games 310A-C may be asynchronous games built for and executable on a particular client device platform (e.g., iOS®, Android®, Windows®, and the like). By way of example, the native game 310A may be configured to execute on the iOS® platform, the native game 310B may be configured to execute on the Android® platform, and the native game 310C may be configured to execute on the Windows® platform. In an example embodiment, each of the platform specific games 310A-C may be built by compiling, linking, and otherwise packaging the third party game engine 304, the asynchronous game API 306, and one of the native platform libraries 308A-C, selected for a particular client device platform.

### EXAMPLE ASYNCHRONOUS GAME MESSAGES

As described above, an asynchronous game may involve one or more client devices coordinating with the game platform 112 to execute a match played by multiple players. Such coordination may be used to create user game accounts, maintain game board data across multiple client devices, signaling that a turn was made, and the like. For example, a client device my update the game data stored on the game platform after a player's turn so that other client devices may obtain the current state of the game board when other players play their turns.

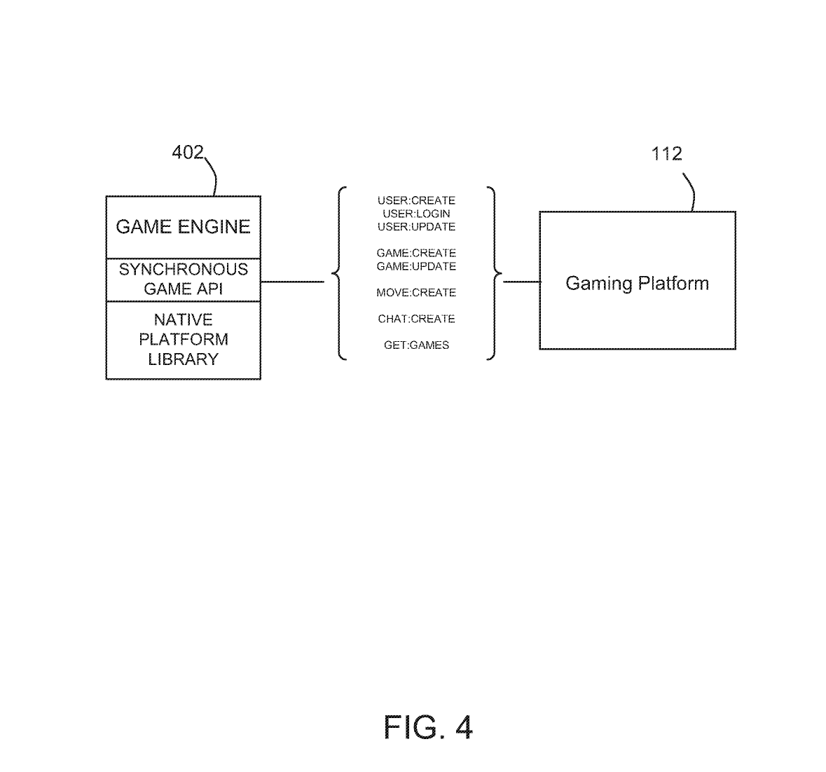

FIG. 4 is a diagram illustrating a native game 402, as may be executed on the client device 104 of FIG. 1, sending asynchronous game messages to the gaming platform 112, according to an example embodiment. As FIG. 4 shows, the native game 402 may send the following asynchronous game messages: user::create to create a user game account on the game platform 112, user:login to authenticate/verify a user's credentials, user:update to update a user's profile (e.g., name, address, billing information, etc), game:create to create an instance of an asynchronous game, game:update to update an existing game (e.g., update the state of a game board), move:create to associate a move with a game, chat:create to associate a chat record with a game board, and get:games to obtain the active games associated with the player.

It is to be appreciated that the native platform libraries (e.g., native platform libraries 308A-C) provide the functionality to execute these operations with the gaming platform 112, as well as the functionality to handle and responses. In some cases, these functions are performed by using native services of a client device platform.

### EXAMPLE DATA MODEL

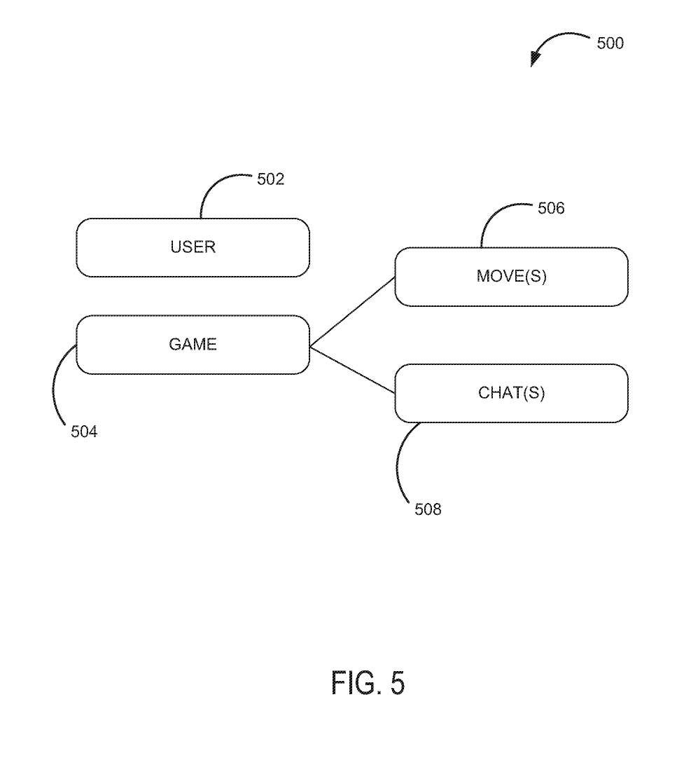

FIG. 5 is a diagram illustrating an example data model 500 utilized by a native platform library, according to an example embodiment. For example, the data model 500 may include a user record 502 and a game record 504 associated with one or more move records 506 and one or more chat records 508. The user record 502 may include properties associated with a user, such as a name, address, date of birth, a user identifier, and the like.

The game record 504 may include properties associated with a match, such as an opponent, game state, and the like. In some embodiments, the game state may be a data structure defined by the game engine 304.

Each of the move records 506 may include data pertaining to a move, such as a game action, a prior game state, a player identifier, a move identifier, a new game state, and the like.

The chat records 508 may each include data regarding a communication messages exchanged between players of an asynchronous game. The chat records 508 may each include a message, a target player (e.g., the player that is receiving the message), a source player (e.g., the player sending the message), and the like.

### Building an Asynchronous Game

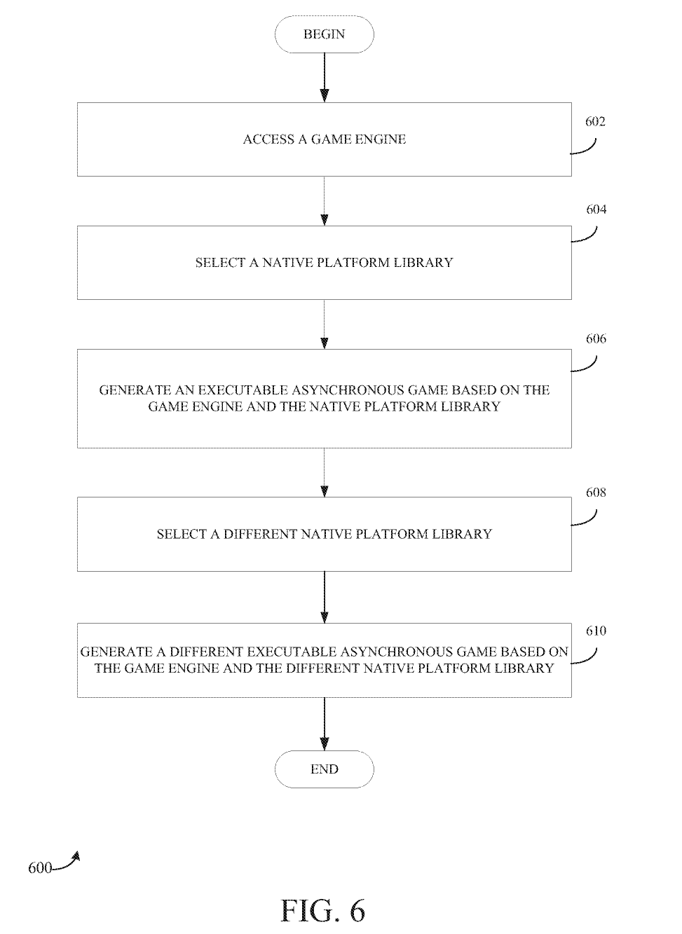

FIG. 6 is a flowchart diagram illustrating a method 600 for generating asynchronous games across different client device platforms, according to an example embodiment. The method 600 may be performed by the compilation module 302 shown in FIG. 3 and, accordingly, is described herein merely by way of reference thereto. However, it will be appreciated that the method 600 may be performed on any suitable hardware.

The method 600 may begin at operation 602 when the compilation module 302 accesses the game engine 304 that includes game play logic that specifies an execution of a turn in the asynchronous game. In some cases, the game play logic may be independent of a client device platform. For example, as described above, relative to FIG. 3, the game engine 304 may specify a data structure of a game board and rules and logic for how players may interact with the game board. By way of example and not limitation, the game engine 304 may specify that the game board is a grid and players may initiate game actions that place tiles representing letters onto the spaces created by the grid to form a word. The game engine 304 may be developed using Unity®, LUA®, Cocos2d-x®, JavaScript®, or any suitable game development language. In some embodiments, the game engine 304 may have the ability to communicate with the C++ programming language.

The compilation module 302 may then select a native platform library (e.g., the native platform library 308A) that includes functions to coordinate game activities within the asynchronous game. The functions included in the native platform library may be dependent on the client device platform. These coordinating functions may include, as an example, starting a game instance, submitting a move made in a game instance, or initiating a chat. In many cases, coordinating the game activities may involve setting up a network connection with a game server (using functions provided by a client device platform) and communicating game events. Accordingly, the coordinating functions may use native services provided by a client device platform.

At operation 606, the compilation module 302 generates an executable game based on compiling the selected native platform library with the game engine. It is to be appreciated that the executable game may be configured to execute on a specific client device platform, such iOS®, Android®, Windows®, or any other suitable client device platform. Thus, after the executable game is generated, it may be downloaded by client devices operating a compatible client device platform.

As FIG. 6 shows, in some embodiments, the compilation module 302 may build another asynchronous game for a different client device platform. For example, the compilation module 302 may, at operation 608, select a different native platform library (e.g., the native platform library 308B) that includes functions specific to a different client device platform. Similar to the functions of the native platform library 308A (as was selected relative to operation 604), the functions of the native platform library 308B may also relate to coordinating game activities within an asynchronous game, such as starting a game instance, submitting a move made in a game instance, or initiating a chat. However, the native platform library 308B may use native functions provided by a client device platform that are different from the native functions used by the native platform library 308A.

At operation 610, the compilation module 302 generates a different executable game based on compiling the different native platform library with the game engine. Like the executable game generated at operation 606, the different executable game may be configured to execute on a specific client device platform, such iOS®, Android®, Windows®, or any other suitable client device platform. Thus, after the executable game is generated, it may be downloaded by client devices operating a compatible client device platform.

However, it is to be appreciated that the method 600 of generating executable asynchronous games may be used to streamline and more efficiently develop asynchronous games. Such may be the case because according to some embodiments, some aspects or features for synchronizing a match between players are generalized at the native platform library level. Thus, multiple game titles may reuse these features, for example, to create a match between players or send chat messages to the players involved in a match. Further, for a single game title, the various native platform libraries each include code that make use of native features of a client device platform. Thus, a game may be released for multiple platforms by compiling the game engine against the relevant native platform libraries.

### EXAMPLE USE CASES

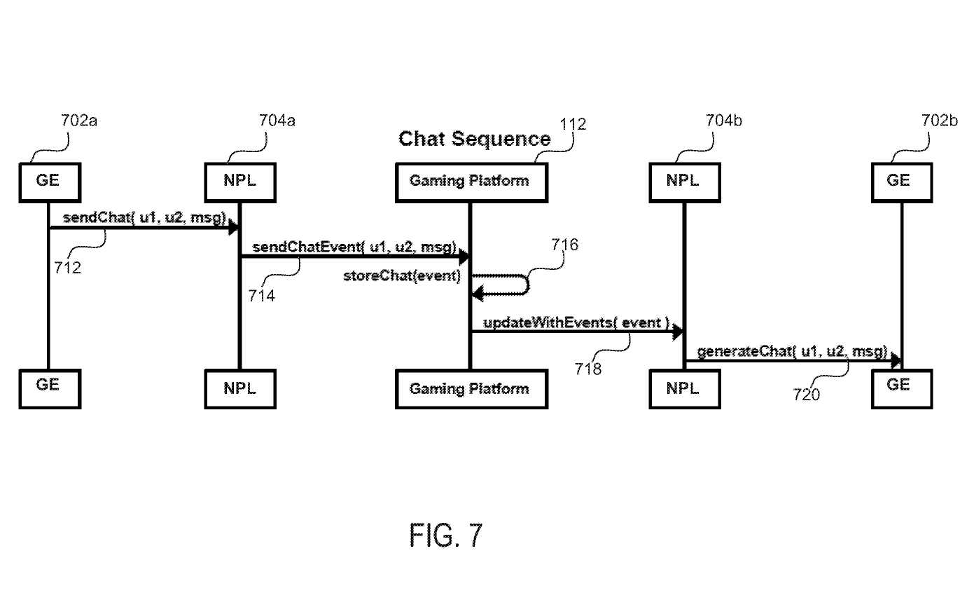

Example use cases illustrating example interactions between game engines, native platform libraries, and the gaming platform are now described in greater detail. For example, FIG. 7 is a sequence diagram illustrating a method 700 of facilitating a chat mechanism in an asynchronous game, according to an example embodiment. As shown in FIG. 7, the method 700 may be performed by game engines 702a, 702b, native platform libraries 704a, 704b, and the gaming platform 112. The game engine 702a and the native platform library 704a may form a compiled executable game operable on a client device, as may be operated by a first user (referred to as a sending user). The game engine 702b and the native platform library 704b may form another compiled executable game operable on a different client device, as may be operated by a second user (referred to as a receiving user).

The method 700 may begin at operation 712 when the game engine 702 causes the native platform library 704a to initiate a mechanism of sending a chat message from one game client to another game client. In an example embodiment, as shown in FIG. 7, the game engine 702a may initiate the mechanism of sending the chat message by invoking the sendChat operation supported by the native platform library 704a. In an example embodiment, the sendChat operation may be a method exposed by an API defined by an asynchronous game API (see, e.g., reference 306 of FIG. 3) and implemented by the native platform library 704a. As FIG. 7 illustrates, the sendChat operation may include a parameter (u1) to identify the sending user (e.g., the user that is sending or otherwise initiating the sending of the chat message a parameter (u2) to identify the receiving user (e.g., that is the user that is to receive the chat message), and a parameter (e.g., msg) to represent the message being exchanged.

At operation 714, responsive to the initiation of the mechanism for sending the chat message, the native platform library 704a may perform the sendChat operation. The sendChat operation may involve the native platform library 704a establishing a network connection with the gaining platform 112 and then communicating the chat message to the gaming platform 112. Sending the chat message, in some embodiments, may be accomplished by the native platform library 704a communicating a chat event that include data representing the sending or initiating user (u1), the receiving user (u2), and the message. It is to be appreciated that in other example embodiments, the native platform library 704a may include further data, such as header information representing the title of the game associated with the chat, an instance of a match between the sending and receiving players, and communication headers, such as IP address, port identifiers, and the like.

At operation 716, the gaming platform 112 stores the chat event in a data store. The data store may provide an interface for the gaining platform 112 to retrieve the chat event according to any number of keys, such as any combination of: a player identifier (e.g., by user identifiers associated with the sending or receiving players), identifiers associated with an instance of a match between the sending and receiving players, an identifier for chat thread, an identifier for a message within the chat, or the like. An example of the format used to store the chat event is represented as reference 508 in FIG. 5.

With continued reference to FIG. 7, at operation 718, the gaming platform 112 updates the native platform library 704b with the chat event. Operation 718 may involve, according to some embodiments, the native platform library 704b pulling the chat event from the gaming platform 112 based on a loop that periodically polls the gaining platform 112 for new events associated with an instance of a match, a game title, a player, or some combination thereof. Alternatively or additionally, according to some embodiments, the gaining platform 112 may push the chat event to the native platform library responsive to the native platform library 704b being connected to the gaming platform 112, as may be the case when the receiving player is playing the game title. Accordingly, if the native platform library 704b is not connected to the gaming platform 112, the gaming platform may store the chat event until the gaming platform 112 detects a connection between the gaming platform 112 and the native platform library 704b.

At operation 720, the native platform library 704b communicates the chat message to the game engine 702b. Once the game engine 702b obtains the chat message, the game engine 702b may display an alert or notification of the message to the receiving user, or otherwise provide the user access to the message.

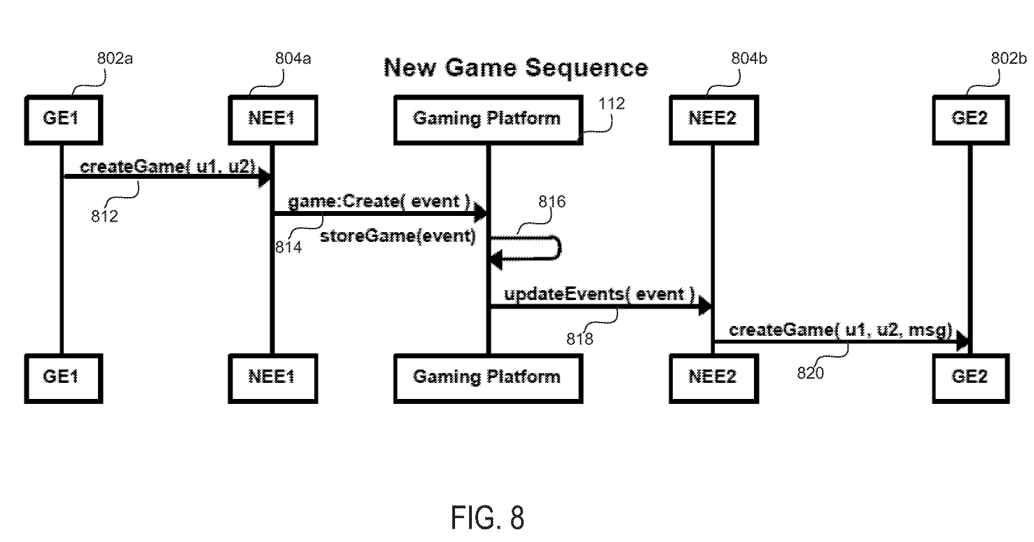

As an example of another use case, FIG. 8 is a sequence diagram illustrating a method 800 of creating an instance of a game (e.g., a match between two or more players) in an asynchronous game, according to an example embodiment. As shown in FIG. 8, the method 800 may be performed by game engines 802a, 802b, native platform libraries 804a, 804b, and the gaming platform 112. The game engine 802a and the native platform library 804a may form a compiled executable game operable on a client device, as may be operated by a first user (referred to as the initiating user). The game engine 802b and the native platform library 804b may form another compiled executable game operable on a different client device, as may be operated by a second user (referred to as invited user).

The method 800 may begin at operation 812 when the game engine 802 causes the native platform library 804a to initiate a mechanism of creating a game between multiple users. In an example embodiment, as shown in FIG. 8, the game engine 802a may initiate the mechanism creating a game by invoking the createGame operation supported by the native platform library 804a. In an example embodiment, the createGame operation may be a method exposed by an API defined by an asynchronous game API (see, e.g., reference 306 of FIG. 3) and implemented by the native platform library 804a. As FIG. 8 illustrates, the createGame operation may include a parameter (u1) to identify the initiating user and a parameter (u2) to identify the invited user.

At operation 814, responsive to the initiation of the mechanism for creating the game, the native platform library 804a may perform the createGame operation. The createGame operation may involve the native platform library 804a establishing a network connection with the gaming platform 112 and then communicating an indication that a game is created to the gaming platform 112. Sending the indication that the game is created, in some embodiments, may be accomplished by the native platform library 804a communicating a game:create event that includes data representing the initiating user (u1), the invited user (u2), and optional game specific game data. It is to be appreciated that in other example embodiments, the native platform library 804a may include further data, such as communication headers, such as IP addresses, port identifiers, and the like.

At operation 816, the gaming platform 112 stores the game:create event in a data store. The data store may provide an interface for the gaming platform 112 to retrieve game related data according to any number of keys, such as any combination of: a player identifier (e.g., by user identifiers associated with the sending or receiving players), identifiers associated with an instance of a match between the sending and receiving players, an identifier for chat thread, an identifier for a message within the chat, or the like. An example of the format used to store the game:create event is represented as reference 504 in FIG. 5.

At operation 818, the gaming platform 112 updates the native platform library 804b with the game:create event. Operation 818 may involve, according to some embodiments, the native platform library 804b pulling the game:create event from the gaming platform 112 based on a loop that periodically polls the gaming platform 112 for new events associated with an instance of a match, a game title, a player, or some combination thereof. Alternatively, or additionally, according to some embodiments, the gaming platform 112 may push the game:create event to the native platform library responsive to the native platform library 804b being connected to the gaming platform 112, as may be the case when the receiving player is playing the game title. Accordingly, if the native platform library 804b is not connected to the gaming platform 112, the gaining platform may store the chat event until the gaming platform 112 detects a connection between the gaming platform 112 and the native platform library 804b.

At operation 820, the native platform library 804b communicates the game:create event to the game engine 802b. Once the game engine 802b obtains the game:create message, the game engine 802b may display an alert or notification that anew game has been initiated by the initiating user.

Once a game has been created, the users may then begin playing the game. Generally, in asynchronous games, one user may complete a turn and then the other user completes their turn. The game specific data and logic used to perform a turn is executed by the game engines. For example, in a word forming game, such as Scramble With Friends®, by Zynga®, the game engine may control the aspects of maintaining the time of a turn, initial configuration (e.g., forming a grid of letter tiles), handling user input(e.g., forming a word), verifying a word, calculating a score for the turn, and the like.

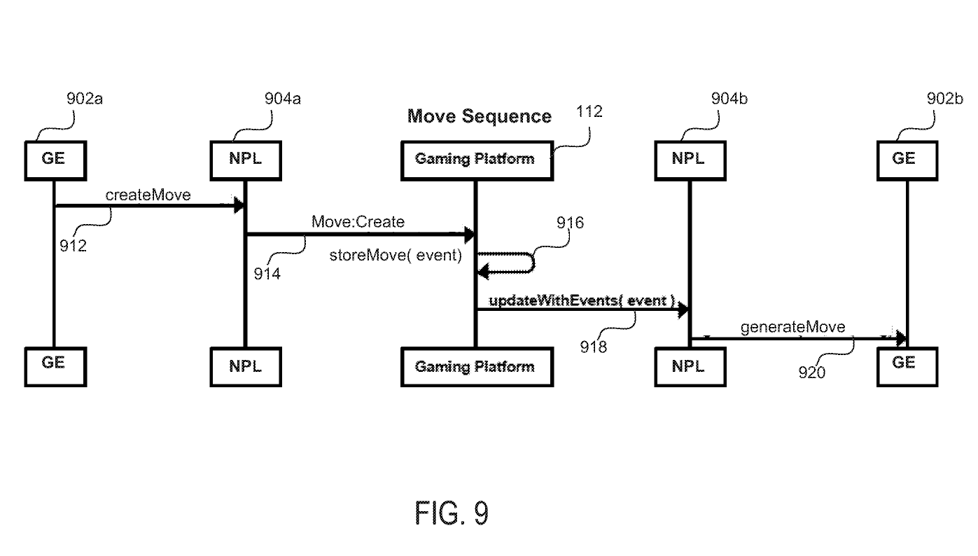

Once a game ends, however, the game engine may then utilize the native platform library to communicate the move to the other user. FIG. 9 is a sequence diagram illustrating a method 900 of creating a game (e.g., a match between two or more players) in an asynchronous game, according to an example embodiment. As shown in FIG. 9, the method 900 may be performed by game engines 902a, 902b, native platform libraries 904a, 904b, and the gaining platform 112. The game engine 902a and the native platform library 904a may form a compiled executable game operable on a client device, as may be operated by a first user (referred to as the first user). The game engine 902b and the native platform library 904b may form another compiled executable game operable on a different client device, as may be operated by a second user (referred to as the second user).

The method 900 may begin at operation 912 when the game engine 902 causes the native platform library 904a to initiate a mechanism of communicating a move performed by the first player to the second player. In an example embodiment, as shown in FIG. 9, the game engine 902a may initiate the mechanism that communicates the move by invoking a createMove operation supported by the native platform library 904a. In an example embodiment, the createMove operation may be a method exposed by an API defined by an asynchronous game API (see, e.g., reference 306 of FIG. 3) and implemented by the native platform library 904a. Although not shown in FIG. 9, the createMove operation may include a number of parameters, such as a player ID for the player performing the move, game specific state the represents the turn or the new state of the game board, a player ID for the player playing against the player making the move, a game ID to identify a game record (e.g., the game record 504 shown in FIG. 5) associated with the match between the players, and the like.

At operation 914, responsive to the initiation of the mechanism for creating the move, the native platform library 904a may perform the createMove operation. The createMove operation may involve the native platform library 904a establishing a network connection with the gaming platform 112 and then communicating, to the gaming platform 112, that a move for a game is created. Sending the indication that the move is created, in some embodiments, may be accomplished by the native platform library 904a communicating a move:create event that includes data representing a parameter to identify the player performing the move, a parameter to identify a score for the turn, a parameter to identify game specific state the represents the turn, a game ID to identify a corresponding game record. It is to be appreciated that in other example embodiments, the native platform library 904a may include further data with the move:create event, such as communication headers, such as IP addresses, port identifiers, and the like.

At operation 916, the gaming platform 112 stores the move:create event in a data store. The data store may provide an interface for the gaming platform 112 to retrieve game related data according to any number of keys, such as any combination of: a player identifier (e.g., by user identifiers associated with the sending or receiving players), identifiers associated with an instance of a match between the sending and receiving players, an identifier for a message within the chat, or the like. An example of the format used to store the move:create event is represented in FIG. 5.

At operation 918, the gaming platform 112 updates the native platform library 904b with the game:create event. Operation 918 may involve, according to some embodiments, the native platform library 904b pulling the game:create event from the gaming platform 112 based on a loop that periodically polls the gaming platform 112 for new events associated with an instance of a match, a game title, a player, or some combination thereof. Alternatively or additionally, according to some embodiments, the gaming platform 112 may push the game:create event to the native platform library responsive to the native platform library 904b being connected to the gaming platform 112, as may be the case when the receiving player is playing the game title. Accordingly, if the native platform library 904b is not connected to the gaming platform 112, the gaining platform may store the chat event until the gaming platform 112 detects a connection between the gaming platform 112 and the native platform library 904b.

At operation 920, the native platform library 904b communicates the game:create event to the game engine 902b. Once the game engine 902b obtains the game:create message, the game engine 902b may display an alert or notification that a new game has been initiated by the initiating user.

### EXAMPLE GAME SYSTEMS, SOCIAL NETWORKS, AND SOCIAL GRAPHS

As described above, the systems described herein may include, communicate, or otherwise interact with a game system. As such, the game system is now described to illustrate further embodiments. In an online multiuser game, users control player characters (PCs), a game engine controls non-player characters (NPCs), and the game engine also manages player character state and tracks states for currently active (e.g., online) users and currently inactive (e.g., offline) users.

A player character may have a set of attributes and a set of friends associated with the player character. As used herein, the terms “state” and “attribute” can be used interchangeably to refer to any game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state, and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a user (or a group of more than one users), the game engine may take into account the state of the player character (or group of player characters (PCs)) that is playing, but also the state of one or more PCs of offline/inactive users who are connected to the current user (or PC, or group of PCs) through the game social graph but are not necessarily involved in the game at the time.

For example, User A with six friends on User A's team (e.g., the friends that are listed as being in the user's mob/gang/set/army/business/crew/etc., depending on the nature of the game) may be playing the virtual game and choose to confront User B who has 20 friends on User B's team. In some embodiments, a user may only have first-degree friends on the user's team. In other embodiments, a user may also have second-degree and higher degree friends on the user's team. To resolve the game event, in some embodiments, the game engine may total up the weapon strength of the seven members of User A's team and the weapon strength of the 21 members of User B's team and decide an outcome of the confrontation based on a random variable applied to a probability distribution that favors the side with the greater total. In some embodiments, all of this may be done without any other current active participants other than User A (e.g., User A's friends, User, B, and User B's friends could all be offline or inactive). In some embodiments, the friends in a user's team may see a change in their state as part of the outcome of the game event. In some embodiments, the state (e.g., assets, condition, level) of friends beyond the first degree are taken into account.

### EXAMPLE GAMING PLATFORMS

A virtual game may be hosted by the gaming platform 112, which can be accessed using any suitable connection with a suitable client device 104. A user may have a game account on the gaming platform 112, wherein the game account may contain a variety of information associated with the user (e.g., the user's personal information, financial information, purchase history, player character state, game state, etc.). In some embodiments, a user 102 may play multiple games on the gaming platform 112, which may maintain a single game account for the user with respect to the multiple games, or multiple individual game accounts for each game with respect to the user. In some embodiments, the gaming platform 112 may assign a unique identifier to a user 102 of a virtual game hosted on the gaining platform 112. The gaming platform 112 may determine that the user 102 is accessing the virtual game by reading the user's cookies, which may be appended to HTTP requests transmitted by the client device 104, and/or by the user 102 logging onto the virtual game.

In some embodiments, the user 102 accesses a virtual game and controls the game's progress via the client device 104 (e.g., by inputting commands to the game at the client device 104). The client device 104 can display the game interface, receive inputs from the user 102, transmit user inputs or other events to the game engine, and receive instructions from the game engine. The game engine can be executed on any suitable system (such as, for example, the client device 104, the social networking system 108, or the gaming platform 112). For example, the client device 104 may download client components of a virtual game, which are executed locally, while a remote game server, such as the gaming platform 112, provides backend support for the client components and may be responsible for maintaining application data of the game, processing the inputs from the user 102, updating and/or synchronizing the game state based on the game logic and each input from the user 102, and transmitting instructions to the client device 104. As another example, when the user 102 provides an input to the game through the client device 104 (such as, for example, by typing on the keyboard or clicking the mouse of the client device 104), the client components of the game may transmit the user's input to the gaming platform 112.

In some embodiments, the user 102 accesses particular game instances of a virtual game. A game instance is a copy of a specific game play area that is created during runtime. In some embodiments, a game instance is a discrete game play area where one or more users 102 can interact in asynchronous or synchronous play. A game instance may be, for example, a level, zone, area, region, location, virtual space, or other suitable play area. A game instance may be populated by one or more game objects. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either asynchronously or synchronously with the specific user's game play. For example, a first user may be associated with a first game instance, but the first game instance may be accessed by all first-degree friends in the first user's social network.

In some embodiments, the set of game actions available to a specific user is different in a game instance that is associated with this user compared to a game instance that is not associated with this user. The set of game actions available to a specific user in a game instance associated with this user may be a subset, superset, or independent of the set of game actions available to this user in a game instance that is not associated with him. For example, a first user may be associated with Blackacre Farm in an online farming game, and may be able to plant crops on Blackacre Farm. If the first user accesses a game instance associated with another user, such as Whiteacre Farm, the game engine may not allow the first user to plant crops in that game instance. However, other game actions may be available to the first user, such as watering or fertilizing crops on Whiteacre Farm.

In some embodiments, a game engine interfaces with a social graph. Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the gaming platform 112, which is managed by the game operator. In other embodiments, the social graph is part of a social networking system 108 managed by a third party (e.g., Facebook, Friendster, Myspace). In yet other embodiments, the user 102 has a social network on both the gaming platform 112 and the social networking system 108, wherein the user 102 can have a social network on the gaming platform 112 that is a subset, superset, or independent of the user's social network on the social networking system 108. In such combined systems, gaming platform 112 can maintain social graph information with edge-type attributes that indicate whether a given friend is an “in-game friend,” an “out-of-game friend,” or both. The various embodiments disclosed herein are operable when the social graph is managed by the social networking system 108, the gaming platform 112, or both.

### EXAMPLE SYSTEMS AND METHODS

Returning to FIG. 2, the User Player may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “user” and “player” can be used interchangeably and can refer to any user in an online multiuser game system or social networking system. As used herein, the term “friend” can mean any node within a user's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 11 211 and Friend 21 221. In the social graph 200, it is possible for individuals to be connected to other individuals through their first-degree friends (e.g., friends of friends). As described above, the number of edges in a minimum path that connects a user to another user is considered the degree of separation. For example, FIG. 2 shows that Player 201 has three second-degree friends to which Player 201 is connected via Player 201's connection to Player 201's first-degree friends. Second-degree Friend 8 212 and Friend 22 222 are connected to Player 201 via Player 201's first-degree Friend 11 211. The limit on the depth of friend connections, or the number of degrees of separation for associations, that Player 201 is allowed is typically dictated by the restrictions and policies implemented by the social networking system 108.

In various embodiments, Player 201 can have Nth-degree friends connected to him through a chain of intermediary degree friends as indicated in FIG. 2. For example, Nth-degree Friend IN 219 is connected to Player 201 within in-game social network 260 via second-degree Friend 32 232 and one or more other higher-degree friends.

In some embodiments, a user (or player character) has a social graph within an online multiuser game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 11 211 and Friend 21 221 are first-degree friends with Player 201 in Player 201's out-of-game social network 250. Player 201 also has in-game connections 265 to a plurality of users, forming in-game social network 260. Here, Friend 21 221, Friend 31 231, and Friend 41 241 are first-degree friends with Player 201 in Player 201's in-game social network 260. In some embodiments, a game engine can access in-game social network 260, out-of-game social network 250, or both.

In some embodiments, the connections in a user's in-game social network is formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that can be the case.

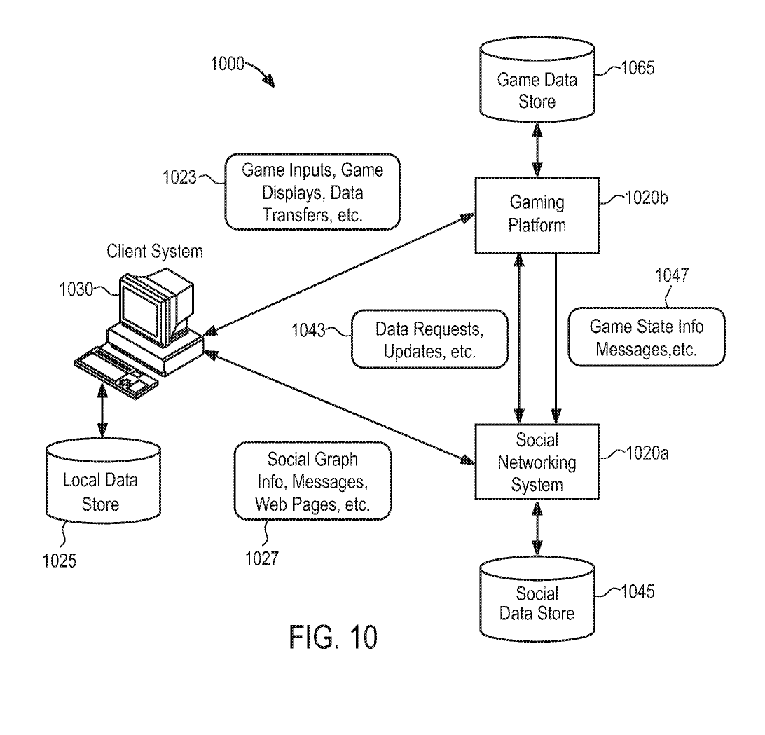

FIG. 10 illustrates an example data flow between example components of an example system 1000. One or more of the components of the example system 1000 may correspond to one or more of the components of the example gaming environment 100. In some embodiments, the system 1000 includes a client system 1030, a social networking system 1020a, and a gaming platform 1020b. The components of system 1000 can be connected to each other in any suitable configuration, using any suitable type of connection. The components may be connected directly or over any suitable network. The client system 1030, the social networking system 1020a, and the gaming platform 1020b may have one or more corresponding data stores such as local data store 1025, social data store 1045, and game data store 1065, respectively.

The client system 1030 may receive and transmit data 1023 to and from the gaming platform 1020b. This data can include, for example, a web page, a message, a game input, a game display, a HTTP packet, a data request, transaction information, and other suitable data. At some other time, or at the same time, the gaming platform 1020b may communicate data 1043, 1047 (e.g., game state information, game system account information, page info, messages, data requests, updates) with other networking systems, such as the social networking system 1020a (e.g., Facebook, Myspace). The client system 1030 can also receive and transmit data 1027 to and from the social networking system 1020a. This data can include, for example, web pages, messages, social graph information, social network displays, HTTP packets, data requests, transaction information, updates, and other suitable data.

Communication between the client system 1030, the social networking system 1020a, and the gaming platform 1020b can occur over any appropriate electronic communication medium or network using any suitable communications protocols. For example, the client system 1030, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the gaming platform 1020b, the BLOB containing the game state for the instance corresponding to the user may be transmitted to the client system 1030 for use by a client-side executed object to process. In some embodiments, the client-side executable is a FLASH-based game, which can de-serialize the game state data in the BLOB. As a user plays the game, the game logic implemented at the client system 1030 maintains and modifies the various game state parameters locally. The client-side game logic may also batch game events, such as mouse clicks, and transmit these events to the gaming platform 1020b. Gaming platform 1020b may itself operate by retrieving a copy of the BLOB from a database or an intermediate memory cache (memcache) layer. The gaming platform 1020b can also de-serialize the BLOB to resolve the game state parameters and execute its own game logic based on the events in the batch file of events transmitted by the client to synchronize the game state on the server side. The gaming platform 1020b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 1030. For example, a client application downloaded to the client system 1030 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages are associated with or accessed by the social networking system 1020a. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (e.g., be updated) at any time. When an update to an application datum occurs at the client system 1030, either caused by an action of a game user or by the game logic itself, the client system 1030 may need to inform the gaming platform 1020b of the update. For example, if the game is a farming game with a harvest mechanic (such as Zynga FarmVille), an event can correspond to a user clicking on a parcel of land to harvest a crop. In such an instance, the application event data may identify an event or action harvest) and an object in the game to which the event or action applies.

In some embodiments, one or more objects of a game are represented as an Adobe Flash object. Flash may manipulate vector and raster graphics, and supports bidirectional streaming of audio and video. “Flash” may mean the authoring environment, the user, or the application files. In some embodiments, the client system 1030 may include a Flash client. The Flash client may be configured to receive and run the Flash application or game object code from any suitable networking system (such as, for example, the social networking system 1020a or the gaming platform 1020b). In some embodiments, the Flash client is run in a browser client executed on the client system 1030. A user can interact with Flash objects using the client system 1030 and the Flash client. The Flash objects can represent a variety of game objects. Thus, the user may perform various game actions on various game objects by making various changes and updates to the associated Flash objects.

In some embodiments, game actions are initiated by clicking or similarly interacting with a Flash object that represents a particular game object. For example, a user can interact with a Flash object to use, move, rotate, delete, attack, shoot, or harvest a game object. This disclosure contemplates performing any suitable game action by interacting with any suitable Flash object. In some embodiments, when the user makes a change to a Hash object representing a game object, the client executed game logic may update one or more game state parameters associated with the game object. To ensure synchronization between the Flash object shown to the user at the client system 1030, the Flash client may send the events that caused the game state changes to the game object to the gaming platform 1020b. However, to expedite the processing and hence the speed of the overall gaming experience, the Flash client my collect a batch of some number of events or updates into a batch file. The number of events or updates may be determined by the Flash client dynamically or determined by the gaming platform 1020b based on server loads or other factors. For example, client system 1030 may send a batch file to the gaming platform 1020b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 1030, the gaming platform 1020b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, gaming platform 1020b may retrieve the corresponding BLOB from the database to determine the most-recent values of the game-related data. In some embodiments, while a user is playing the virtual game, the gaming platform 1020b also loads the corresponding BLOB into a memory cache so that the game system may have faster access to the BLOB and the game-related data contained therein.

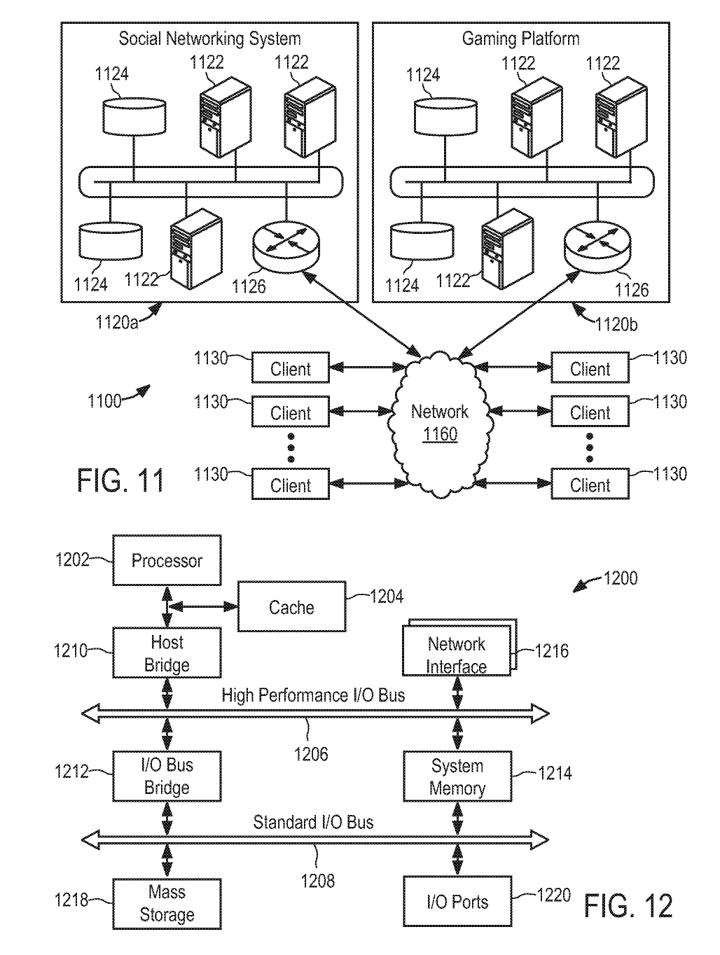

Various embodiments may operate in a wide area network environment, such as the Internet, including multiple network addressable systems. FIG. 11 illustrates an example network environment 1100, in which various example embodiments may operate. Network cloud 1160 generally represents one or more interconnected networks, over which the systems and hosts described herein can communicate. The network cloud 1160 may include packet-based WANs (such as the Internet), private networks, wireless networks, satellite networks, cellular networks, paging networks, and the like. As FIG. 11 illustrates, various embodiments may operate in a network environment 1100 comprising one or more networking systems, such as a social networking system 1120a, a gaming platform 1120b, and one or more client systems 1130. The components of the social networking system 1120a and the gaming platform 1120b operate analogously; as such, hereinafter they may be referred to simply as the networking system 1120. The client systems 1130 are operably connected to the network environment 1100 via a network service provider, a wireless carrier, or any other suitable means.

The networking system 1120 is a network addressable system that, in various example embodiments, comprises one or more physical servers 1122 and data stores 1124. The one or more physical servers 1122 are operably connected to the computer network cloud 1160 via, by way of example, a set of routers and/or networking switches 1126. In an example embodiment, the functionality hosted by the one or more physical servers 1122 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 1122 may host functionality directed to the operations of the networking system 1120. Hereinafter, the servers 1122 may be referred to as server 1122, although the server 1122 may include numerous servers hosting, for example, the networking system 1120, as well as other content distribution servers, data stores, and databases. The data store 1124 may store content and data relating to, and enabling operation of, the networking system 1120 as digital data objects. A data object, in some embodiments, is an item of digital information typically stored or embodied in a data tile, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like.

Logically, the data store 1124 corresponds to one or more of a variety of separate and integrated databases, such as relational databases and object-oriented databases, that maintain information as an integrated collection of logically related records or files stored on one or more physical systems. Structurally, the data store 1124 may generally include one or more of a large class of data storage and management systems. In some embodiments, the data store 1124 may be implemented by any suitable physical system(s) including components, such as one or more database servers, mass storage media, media library systems, storage area networks, data storage clouds, and the like. In one example embodiment, the data store 1124 includes one or more servers, databases (e.g., MySQL), and/or data warehouses. Data store 1124 may include data associated with different networking system 1120 users and/or client systems 1130.

The client system 1130 is generally a computer or computing device including functionality for communicating (e.g., remotely) over a computer network. The client system 1130 may be a desktop computer, laptop computer, PDA, in- or out-of-car navigation system, smart phone or other cellular or mobile phone, or mobile gaming device, among other suitable computing devices. The client system 1130 may execute one or more client applications, such as a Web browser.

When a user at the client system 1130 desires to view a particular webpage (hereinafter also referred to as target structured document) hosted by the networking system 1120, the user's web browser, or other document rendering engine or suitable client application, formulates and transmits a request to the networking system 1120. The request generally includes a URL or other document identifier as well as metadata or other information. By way of example, the request may include information identifying the user, a timestamp identifying when the request was transmitted, and/or location information identifying a geographic location of the user's client system 1130 or a logical network location of the user's client system 1130.

Although the example network environment 1100 described above and illustrated in FIG. 11 is described with respect to the social networking system 1120a and the gaming platform 1120b, this disclosure encompasses any suitable network environment using any suitable systems. For example, a network environment may include online media systems, online reviewing systems, online search engines, online advertising systems, or any combination of two or more such systems.

FIG. 12 illustrates an example computing system architecture, which may be used to implement a server 1122 or a client system 1130. In one embodiment, the hardware system 1200 comprises a processor 1202, a cache memory 1204, and one or more executable modules and drivers, stored on a tangible computer-readable storage medium, directed to the functions described herein. Additionally, the hardware system 1200 may include a high performance input/output (I/O) bus 1206 and a standard I/O bus 1208. A host bridge 1210 may couple the processor 1202 to the high performance I/O bus 1206, whereas the I/O bus bridge 1212 couples the two buses 1206 and 1208 to each other. A system memory 1214 and one or more network/communication interfaces 1216 may couple to the bus 1206. The hardware system 1200 may further include video memory (not shown) and a display device coupled to the video memory. Mass storage 1218 and I/O ports 1220 may couple to the bus 1208. The hardware system 1200 may optionally include a keyboard, a pointing device, and a display device (shown) coupled to the bus 1208. Collectively, these elements are intended to represent a broad category of computer hardware systems.

The elements of the hardware system 1200 are described in greater detail below. In particular, the network interface 1216 provides communication between the hardware system 1200 and any of a wide range of networks, such as an Ethernet (e.g., IEEE 802.3) network, a backplane, and the like. The mass storage 1218 provides permanent storage for the data and programming instructions to perform the above-described functions implemented in servers 1222 of FIG. 11, whereas system memory 1214 (e.g., DRAM) provides temporary storage for the data and programming instructions when executed by the processor 1202. I/O ports 1220 are one or more serial and/or parallel communication ports that provide communication between additional peripheral devices, which may be coupled to the hardware system 1200.

The hardware system 1200 may include a variety of system architectures, and various components of the hardware system 1200 may be rearranged. For example, cache memory 1204 may be on-chip with the processor 1202. Alternatively, the cache memory 1204 and the processor 1202 may be packed together as a “processor module,” with processor 1202 being referred to as the “processor core.” Furthermore, certain embodiments of the present disclosure may neither require nor include all of the above components. For example, the peripheral devices shown coupled to the standard I/O bus 1208 may couple to the high performance I/O bus 1206. In addition, in some embodiments, only a single bus may exist, with the components of the hardware system 1200 being coupled to the single bus. Furthermore, the hardware system 1200 may include additional components, such as additional processors, storage devices, or memories.

An operating system manages and controls the operation of the hardware system 1200, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments, the term “web service” and “website” may be used interchangeably and additionally may refer to a custom or generalized API on a device, such as a mobile device (e.g., cellular phone, smart phone, personal GPS, PDA, personal gaming device, etc.), that makes API calls directly to a server. Still further, while the embodiments described above operate with game challenges as may be provided through a quest mechanic), the embodiments can be applied to communication targeted to a user, such as an advertisement, notification, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method of building an asynchronous game, the method comprising:
accessing a game engine defining game play logic specifying an execution of a turn in the asynchronous game, the game play logic being independent of a client device platform;
selecting, by one or more processors, a native platform library that includes functions to coordinate game activities within the asynchronous game, the functions being dependent on the client device platform; and
generating, by the one or more processors, an executable game based on compiling the selected native platform library with the game engine.

2. The method of claim 1, wherein the game engine initiates the coordinating game activity through a function call to one of the functions included by the native platform library.

3. The method of claim 1, wherein the generating the executable game is further based on compiling the selected native platform library with the game engine against a cross-platform asynchronous game application programming interface.

4. The method of claim 3, wherein the cross-platform asynchronous game application programming interface includes declarations of the functions included in the native platform library.

5. The method of claim 1, wherein the game engine code includes a rendering module to display graphics associated with gameplay of a turn.

6. The method of claim 1, wherein the coordinating game activities include establishing a network connection with a game server and sending a message to the game server.

7. The method of claim 6, wherein the message sent to the game server represents at least one of: a request for a user identifier associated with an instance of a game, a request for a game identifier associated with the instance of the game, a request for a move count associated with the instance of the game, an update of a move made in the instance of the game, a request for an game data object, and a request for a turn count associated with the instance of the game.

8. The method of claim 1, further comprising
selecting, by one or more processors, a different native platform library that includes functions to coordinate game activities within the asynchronous game, the functions being dependent on a different client device platform; and
generating, by the one or more processors, a different executable game based on compiling the different native platform library with the game engine.

9. The method of claim 1, wherein the game play logic specifies the execution of the turn in the asynchronous game according to a data structure of a game board and permissible game actions that can be performed with respect to the game board.

10. The method of claim 1, wherein the executable game is made available for download by a plurality of user via an application store specific to the client device platform.

11. A computer-implemented system for building an asynchronous game, the system comprising:
a compilation module implemented by one or more processors and configured to:
access a game engine defining game play logic specifying an execution of a turn in the asynchronous game, the game play logic being independent of a client device platform;
select, by one or more processors, a native platform library that includes functions to coordinate game activities within the asynchronous game, the functions being dependent on the client device platform; and
generate, by the one or more processors, an executable game based on compiling the selected native platform library with the game engine.

12. The system of claim 11, wherein the game engine initiates the coordinating game activity through a function call to one of the functions included by the native platform library.

13. The system of claim 11, wherein the compilation module is further configured to generate the executable game by compiling the selected native platform library with the game engine against a cross-platform asynchronous game application programming interface.

14. The system of claim 13, wherein the cross-platform asynchronous game application programming interface includes declarations of the functions included in the native platform library.

15. The system of claim 11, wherein the game engine code includes a rendering module to display graphics associated with gameplay of a turn.

16. The system of claim 11, wherein the coordinating game activities include establishing a network connection with a game server and sending a message to the game server.

17. The system of claim 16, wherein the message sent to the game server represents at least one of: a request for a user identifier associated with an instance of a game, a request for a game identifier associated with the instance of the game, a request for a move count associated with the instance of the game, an update of a move made in the instance of the game, a request for an game data object, and a request for a turn count associated with the instance of the game.

18. The system of claim 11, wherein the compilation module is further configured to:
select, by one or more processors, a different native platform library that includes functions to coordinate game activities within the asynchronous game, the functions being dependent on a different client device platform; and
generate, by the one or more processors, a different executable game based on compiling the different native platform library with the game engine.

19. The system of claim 11, wherein the game play logic specifies the execution of the turn in the asynchronous game according to a data structure of a game board and permissible game actions that can be performed with respect to the game board.

20. A non-transitory computer-readable medium storing executable instructions thereon, which, when executed by a processor, cause the processor to perform operations comprising:
accessing a game engine defining game play logic specifying an execution of a turn in the asynchronous game, the game play logic being independent of a client device platform;
selecting, by one or more processors, a native platform library that includes functions to coordinate game activities within the asynchronous game, the functions being dependent on the client device platform; and
generating, by the one or more processors, an executable game based on compiling the selected native platform library with the game engine.
